(19) United States
(12) Patent Application Publication
(10) Pub. No.: US 2011/0025116 A1
(43) Pub. Date: Feb. 3, 2011

(54) HEAD-REST GUIDING SLEEVE WITH SECURITY UNLOCKING

(75) Inventor: Jean Philippe Ledieu, Precy Sur Oise (FR)

Correspondence Address: LOWE, HAUPTMAN, HAM & BERNER, LLP (ITW), 1700 DIAGONAL ROAD, SUITE 300, ALEXANDRIA, VA, 22314, US

(73) Assignee: I.T.W. DE FRANCE, Beauchamp (FR)

(21) Appl. No.: 12/937,585

(22) PCT Filed: May 11, 2009
(86) PCT No.: PCT/IB09/51933

§ 371 Date: Oct. 13, 2010

(30) Foreign Application Priority Data
Jun. 13, 2008 (FR) 0853937

(51) Int. Cl. B60N 2/48

(52) U.S. Cl. 297/391

(57) ABSTRACT

A sleeve for a vehicle seat head-rest, including a hollow body which has a first cavity to receive said head-rest, and of which the upper end is surmounted by a top part, in which is formed a second cavity; a locking device adapted to move between a locking position in which it projects into the first cavity and an unlocking position, said device being biased towards its unlocking position by an elastic return means; an unlocking thruster adapted to move in order to push said device, wherein the second cavity issues to the exterior of the top part by an opening of which the size does not enable the insertion of a human finger and in that, over at least a portion of the travel necessary for moving said device from its locking position to its unlocking position, the thruster is positioned entirely within said opening.

The invention relates to a device for locking in position a head-rest for an automotive vehicle seat. More particularly it concerns the means enabling the adjustment in height of that head-rest and the mechanism for locking at the desired height.

A head-rest is already known, in particular from patent application FR2792891, that is adapted to be inserted in a sleeve which is implanted in the back-rest of a seat for the driver or for a passenger of an automotive vehicle and in which a rod may slide which carries the head-rest itself. This rod bears notches regularly disposed along its longitudinal axis, which are adapted to receive a tooth carried by the sleeve in which the head-rest rod slides. This tooth is pushed away by an elastic means towards the inside of the sleeve such that it enters one of the notches which it faces and thus, together with that notch, forms a lock for the rod preventing translational movement The lock so formed prevents the movement of the head-rest whether downwardly towards the lowest position, or upwardly with the risk of possible extraction of the head-rest. By virtue of the multiplicity of notches, it is possible to adjust the height of the rod, and thus of the head-rest, in order for it to be located facing the head of the driver or passenger and thus for it to provide the function of protection against “whiplash” in case of shock.

In general, the tooth, which is biased by an elastic means towards the inside of the sleeve, may be de-activated by an action of the operator with the aim of temporarily freeing it from the notch and so enabling the longitudinal movement of the rod which is necessary for the adjustment of the head-rest. This de-activation is conventionally performed by pressing on a push-button, which pushes the tooth away outwardly. The latter is generally positioned at the upper part of the sleeve, above the corresponding back-rest of the seat.

The invention is directed to improving the security provided by the devices for head-rest locking.

To that end, the invention provides a sleeve for a vehicle seat head-rest, comprising—a hollow body, adapted to be fixed to the back-rest of said seat, which comprises a first cavity of cylindrical form for receiving said head-rest, and of which the upper end is surmounted by a top part, in which is formed a second cavity, a locking device, inserted into said second cavity, adapted to move between a locking position in which it projects into the first cavity of the hollow body and an unlocking position in which it does not project into said first cavity, said device being biased towards its unlocking position by an elastic return means; an unlocking thruster at least partially positioned inside said second cavity and adapted to move in order to push said device towards its unlocking position; characterized in that the second cavity issues to the exterior of the top part by an opening of which the size does not enable the insertion of a human finger and in that, over at least a portion of the travel necessary for moving said device from its locking position to its unlocking position, the thruster is positioned entirely within said opening.

Thus, including in the case in which a certain length of the thruster projects out from the top part, it is necessary to act on that thruster within said opening in order to bring the thruster to its unlocking position.

Relative to the aforementioned devices of the prior art, the thruster of the device according to the invention has the advantage of it not being possible to operate it simply with the fingers of a user. It is thus necessary to have available a complementary device adapted to enter the opening, such as a coin, to actuate the thruster until unlocking of the head-rest rod is achieved.

This avoids in particular an unintended person, and in particular children seated to the rear of the vehicle, being able to operate this device and thus to put the height of the head-rest out of adjustment without the person seated on the seat concerned realizing it. In case of shock the head of the driver or of the front passenger would no longer be effectively protected and serious lesions could occur.

According to preferred features:
said thruster is, in the locking position, positioned entirely within said opening and does not project from the top part;
the opening formed in said top part is in the form of a slot which is adapted to enable the passage of a flat object of the size of a coin;
said locking device is a tooth adapted to cooperate with female locking members of notch type formed in the part of the head-rest which enters the first cavity;
the elastic return means has the form of a two-strip member of which one of the strips is inserted into the body of the locking device;
said top part has an insert in the form of a fixed button, in which the opening is made;
the top part has a cut-out adapted to receive the fixed button, having a tapered form;
said cut-out is adapted to receive the fixed button when translational motion is imparted to it in the direction of the axis of the hollow body;
said cut-out is adapted to receive the fixed button when motion is imparted to it which is translation along an axis perpendicular to the axis of the sleeve, and which is sliding over the base of the top part.

The disclosure of the invention will now be continued with the description of a preferred embodiment, given below by way of illustrative and non-limiting example, with reference to the accompanying drawings. In the drawings:

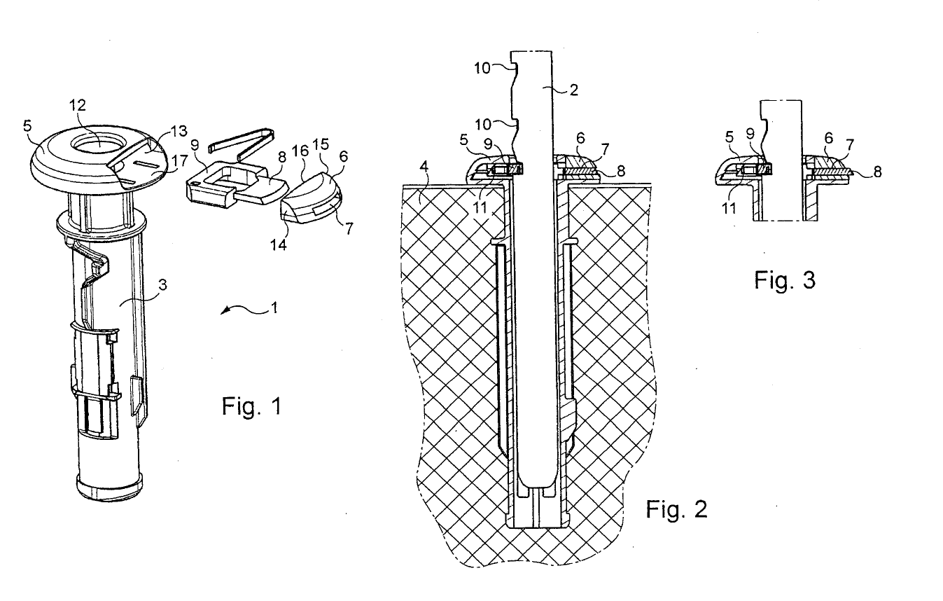

FIG. 1 is a perspective view of head-rest sleeve according to a first embodiment of the invention,

FIG. 2 is a cross-section view of that sleeve, which is passed through by a head-rest rod in a position of use, and

FIG. 3 is a cross-section view of a detail of the top part of a sleeve according to an embodiment of the invention.

Referring to FIGS. 1 and 2, a guide sleeve 1 for the rod 2 of a head-rest can be seen. The sleeve comprises a hollow body 3, of elongate form, adapted to be permanently implanted in the back-rest 4 of an automotive vehicle seat. This hollow body is substantially in the shape of a tube with, at its centre, a first cavity 12, of cylindrical form, in which the rod of the head-rest will be able to be accommodated. The fixing of the sleeve in the seat is provided by means known to the person skilled in the art, which prevent its movement in the longitudinal direction. The sleeve extends above the height of the back-rest such that its top part 5 is accessible to an operator.

This top part extends laterally in the form of a dish or mushroom cap and is pierced at its center to allow the rod 2 of the head-rest to pass, in continuity with the first cavity 12 of the hollow body 3. On one of the sides of the top part 5 of the sleeve there is an insert in the form of a fixed button 6, analogous to the push-buttons of the prior art which enable the rod to be unlocked when its height is being set. The presence of this fixed button enables the operator to identify the location on which he must act to adjust the height of the head-rest. This fixed button 6 has an opening 7 of slot form which extends in a plane perpendicular to the axis of the hollow body 3 and which is able to allow a flat object to pass such as a coin or a supermarket token.

As represented in FIG. 1, the fixed button 6 takes the form of a piece of dish, which is laterally limited by two planes 14 and 15 parallel to the axis of the sleeve and which is limited in the direction of the axis of the hollow body 3 by a third plane 16, which is also parallel to that axis, and orthogonal to the two preceding planes. The top part 5 is cut out along identical planes so as to constitute a female receptacle adapted to receive, in a manner so as to fit with, the part constituted by the fixed button 6. It also has a flat surface 17, forming a base, extending radially relative to the axis of the sleeve and on which rests the fixed button 6. This cut-out of the top part 5 is of tapered form in order to enable insertion, on assembly, of the fixed button 6 therein; it is then fastened to the top part 5 using means known to the person skilled in the art, such as by clipping or by gluing. Preferably, the cut-out is such that the fixed button 6 may be inserted therein by a translational movement in the direction of the axis of the hollow body 3. The form of the cut-out also enables the insertion of the fixed button 6 by a translational movement made along an axis perpendicular to the axis of the sleeve, by sliding it along the base 17 of the top part 5.

The cut-out made in the top part 5 as is described above is also adapted to receive push-buttons of the prior art, for which the button 6 is rigidly linked to the thruster 8 and mobile therewith. It is thus possible to keep the same manufacturing range as for the production of the hollow bodies 3 of the sleeves of the prior art. Upgrading of these sleeves by replacing the push-buttons of the prior art with thrusters 8 and fixed buttons 6 according to the invention is also possible in order to improve the security of the seats of the vehicles in service.

With reference more particularly to FIG. 2, there can be seen the inside of the top part 5 of the sleeve and the slot 7 through which the flat object can be passed for unlocking. The top part 5 has a second cavity 13 positioned so as to extend in line with slot 7 and in which is positioned a thruster 8 able to move perpendicularly relative to the axis of the sleeve. This thruster 8 is rigidly connected to a tooth 9, forming a locking device, which is situated on the opposite side to the thruster and which is adapted to be inserted, in its locking position, in one of the notches 10, forming female locking members, of the head-rest rod 2. A return spring 11, operating as elastic return means, is positioned between the tooth 9 and the back of the second cavity 13 so as to exert a force tending to push the tooth 9 in the direction of its locking position, that is to say against rod 2, and so to make it enter into one of the notches 10. In the version represented in FIGS. 1 to 3 the return spring has the form of a two-strip member of which one of the strips is inserted into the body of the tooth 9, the other being free and adapted to bear against the back of the second cavity 13. This conformation enables easier putting into place and more precise positioning of this return spring at the back of the second cavity.

In the version represented in FIG. 2 the thruster 8 is, at rest, entirely positioned within the slot 7, without this configuration being imperative; in a second embodiment, represented in FIG. 3, the thruster 8, at rest, that is to say in the locking position, projects slightly from the slot 7 and from the top part 5.

It should be noted that the thruster 8, whether it is placed entirely within the opening 7 or projects slightly from it, can only unlock the rod 2 after having undergone a movement corresponding to the travel of the tooth 9 exiting the notch 10, that is to say at least at the spacing between the locking position and the exiting of the tooth out from the first cavity 12. It thus matters in the second embodiment that the projecting part is of shorter length than said travel for exiting the tooth 9, in other words that, over at least a portion of the travel necessary to move the tooth 9, the thruster 8 is entirely positioned within the opening 7. Without this, it would be possible for a user to unlock the rod simply by pressing on the thruster.

Whatever the version considered, the operator must be obliged to use an object capable of being inserted into the slot 7 to extend the travel of the thruster beyond the first position at which it is entirely positioned within the opening, until unlocking of the tooth 9 is achieved. It is thus necessary for him to perform a conscious action to push in the thruster and unlock the rod 2, by making the tooth 9 come out from the notch 10 in which it is engaged.

A description will now be given of putting a head-rest in place in a sleeve according to the invention.

The head-rest provided with its rod 2 is brought towards the sleeve 1, which is fixed in the back-rest of the seat concerned, and its rod 2 is aligned with the first cavity 12 of the hollow body 3. The operator slides the rod 2 vertically in the sleeve 1 and pushes it in until the tooth 9 of the top part 5 of the sleeve engages in the notch 10 that is situated the lowest on the rod 2, under the action of the return spring 11. In this position the rod 2 is locked and cannot continue its downward movement. To enable the continuation of this movement and position the rod at the desired height, the operator slides a flat object such as a coin into the slot 7 and presses thereon until the tooth 9 comes out from the notch into which it had entered and no longer projects into the first cavity 12. By doing this, the rod 2 is freed and the operator can continue the downward movement, while continuing to press on the flat object, until the rod is approximately situated at the height he desires. He then stops pressing on the flat object, which frees the tooth 9 which returns to press against the rod 2. The operator then makes small vertical movements of the rod 2 until one of the notches 10 is located facing the tooth 9. The tooth, pushed by the return spring, then engages in the corresponding notch and locks the rod heightwise. To terminate, the operator removes the flat object, which thereafter prevents any person not having such an object from operating said rod 2.

The opening 7 formed in the fixed button 6 has been described as a slot. Obviously, it could take another form, such as a lunule or a simple recess formed in the lower face of the fixed button 6, provided that the opening obtained does not enable the insertion of a human finger, even if it be that of a child.

Numerous other variants are possible according to circumstances, and in this connection it is to be noted that the invention is not limited to the examples described and shown.

1. A sleeve for a vehicle seat head-rest, comprising:
a hollow body, adapted to be fixed to the back-rest of said seat, which comprises a first cavity of cylindrical form adapted to receive a part of said head-rest, and of which the upper end is surmounted by a top part, in which is formed a second cavity,
a locking device, inserted into said second cavity, adapted to move between a locking position in which it projects into the first cavity of the hollow body and an unlocking position in which it does not project into said first cavity, said device being biased towards its unlocking position by an elastic return means,
an unlocking thruster at least partially positioned inside said second cavity and adapted to move in order to push said device towards its unlocking position,
wherein the second cavity issues to the exterior of the top part by an opening of which the size does not enable the insertion of a human finger and in that, over at least a portion of the travel necessary for moving said device from its locking position to its unlocking position, the thruster is positioned entirely within said opening.

2. A sleeve for a vehicle seat head-rest according to claim 1 in which the thruster is, in the locking position, positioned entirely within the opening and does not project from the top part.

3. A sleeve for a vehicle seat head-rest according to claim 1 in which the opening formed in the top part is in the form of a slot which is adapted to enable the passage of a flat object of the size of a coin.

4. A sleeve for a vehicle seat head-rest according to claim 1 in which the locking device is a tooth adapted to cooperate with female locking members of notch type formed in the part of the head-rest which enters the first cavity.

5. A sleeve for a vehicle seat head-rest according to claim 1 in which the elastic return means has the form of a two-strip member of which one of the strips is inserted into the body of the locking device.

6. A sleeve for a vehicle seat head-rest according to claim 1 in which the top part has an insert in the form of a fixed button, in which the opening is made.

7. A sleeve for a vehicle seat head-rest according to claim 6 in which the top part has a cut-out adapted to receive the fixed button, having a tapered form.

8. A sleeve for a vehicle seat head-rest according to claim 7 in which said cut-out is adapted to receive the fixed button when translational motion is imparted to it in the direction of the axis of the hollow body.

9. A sleeve for a vehicle seat head-rest according to claim 7 in which said cut-out is adapted to receive the fixed button when motion is imparted to it which is translation along an axis perpendicular to the axis of the sleeve, and which is sliding over the base of the top part.
